(19) United States
(12) Patent Application Publication
(10) Pub. No.: US 2013/0206696 A1
(43) Pub. Date: Aug. 15, 2013

(54) Apparatus and method for treating and disposing of wastewater

(71) Applicants: R. Lee Roberts, Rose Valley, PA (US); Matthew Duross Roberts, Media, PA (US); Mark Robert Battaglia, Wallingford, PA (US); Robert Stanley Chrobak, Alameda, CA (US); Donald John Mackay, Louisville, KY (US)

(72) Inventors: R. Lee Roberts, Rose Valley, PA (US); Matthew Duross Roberts, Media, PA (US); Mark Robert Battaglia, Wallingford, PA (US); Robert Stanley Chrobak, Alameda, CA (US); Donald John Mackay, Louisville, KY (US)

(21) Appl. No.: 13/385,319

(22) Filed: Feb. 14, 2012

(51) Int. Cl. B01D 61/12; C02F 9/02; C02F 1/52; C02F 1/44

(52) U.S. Cl. 210/652; 210/143; 210/739; 210/202

(57) ABSTRACT

An aspect of the present invention is directed to an apparatus and method for treating and disposing of wastewater produced by a facility. This aspect of the present invention is particularly well suited to manage and dispose of wastewater produced by an agricultural processing facility. Treated wastewater is selectively blended with untreated wastewater of the facility and the blended mixture is provided to a disposal unit for disposal. Another aspect of the present invention is directed to a system for maximizing the efficiency of an impurity removal unit designed to remove at least one impurity from a liquid. More specifically, this system is preferably designed to blend influent entering the impurity removal unit with another source of liquid to ensure that the liquid treated by the impurity removal unit has an impurity concentration approximately equal to the maximum impurity concentration that the impurity removal unit can satisfactorily process.

### FIELD OF THE INVENTION

A preferred form of the present invention is directed to an apparatus and method for treating and disposing of wastewater produced by a facility. A preferred form of the present invention is particularly well suited to manage and dispose of wastewater produced by an agricultural processing facility (e.g., a winery) without increasing the volume of the wastewater that must be disposed. One aspect of a preferred form of the present invention includes a system for maximizing the efficiency of an impurity removal unit designed to remove at least one impurity from a liquid. This system is particularly well suited for wastewater treatment but also can be used to treat water. More specifically, this system is preferably designed to blend influent entering the impurity removal unit with another source of liquid to ensure that the liquid treated by the impurity removal unit has an impurity concentration approximately equal to the maximum impurity concentration that the impurity removal unit can satisfactorily process. The influent to be treated by the impurity removal unit can be blended with effluent from the impurity removal unit, the waste discharged from the impurity removal unit or other sources to optimize the efficiency of the impurity removal unit. In its most preferred form, the impurity removal unit is a dissolved solids removal unit, e.g. a reverse osmosis unit. Another aspect of the present invention allows for the blending of treated wastewater with untreated wastewater of the facility and providing the blended mixture to a disposal unit. In the most preferred form, the disposal unit is an irrigation unit for irrigating the land adjacent the agricultural processing facility. The blending is controlled so that the blended mixture applied to the land does not adversely affect the ground water.

Another aspect of the present invention is the use of a flocculator upstream of a dissolved air flotation unit where the flocculator includes a source of air to agitate the liquid prior to entering the dissolved air flotation unit to promote flocculation. The air also increases the level of dissolved air in the liquid to be treated by the dissolved air flotation unit to allow the dissolved air flotation unit to treat liquid with a low level of dissolved air without increasing the size of the saturator of the dissolved air flotation unit resulting in a significant cost savings. The flocculator upstream of a dissolved air flotation unit in accordance with this embodiment of the present invention can be used in both water and wastewater applications.

### BACKGROUND OF THE INVENTION

Agricultural processing facilities (e.g., a winery) produce a great deal of wastewater which must be disposed of in some manner. The wastewater is typically stored in one or more waste storage areas. The waste storage areas can be ponds formed in the land adjacent the agricultural processing facility. One of the most cost effective ways to dispose of the wastewater accumulated in the one or more waste storage areas is through irrigation of the land adjacent the agricultural processing facility. However, regulations in various jurisdictions preclude irrigation where the liquid being irrigated will adversely affect the ground water. This is particularly problematic where all of the waste storage ponds are filled to capacity and the levels of one or more impurities in the wastewater in the storage ponds preclude irrigation as a disposal method. The facility owner is then forced to dig additional waste ponds and/or acquire artificial storage containers to store the wastewater. The disadvantages of these options are readily apparent. In the case of digging additional waste storage ponds, the facility owner is decreasing the area of the land that can be used or is forced to purchase additional land at considerable expense. Artificial containers are costly and again take up valuable space.

Another significant problem with the management and disposal of wastewater generated by agricultural processing facilities is that the volumetric flow and contamination concentration of the wastewater produced by the facilities varies greatly throughout the year. These variables create a high level of unpredictability in the characteristics of the wastewater including the concentration of Total Dissolved Solids (TDS) and Fixed Dissolved Solids (FDS). TDS and FDS loading on the soil is of paramount regulatory concern. The most efficient method of FDS and TDS removal is Reverse Osmosis (RO). In operating a Reverse Osmosis Treatment System, it is important to optimize the feed source to provide an efficient and sustainable finished product. Reverse Osmosis Membranes operate most efficiently when the contaminant concentration and volumetric flow rate of the liquid being processed by the membranes are constant. The varying conditions of the production wastewater produced by an agricultural processing facility make optimizing the Reverse Osmosis System particularly problematic. One aspect of the present invention provides a system and method of maximizing the efficiency of an impurity removal unit (e.g., Reverse Osmosis Membranes) while maintaining regulatory compliance.

### OBJECTS AND SUMMARY OF THE INVENTION

An object of a preferred embodiment of the present invention is to provide a novel and unobvious apparatus and method for managing and disposing of wastewater produced by an agricultural processing facility.

Another object of a preferred embodiment of the present invention is to provide an apparatus and method for managing and disposing of wastewater produced by an agricultural processing facility without increasing the volume of wastewater.

A further object of a preferred embodiment of the present invention is to provide a system for maximizing the efficiency of an impurities removal unit by ensuring that the liquid treated by the impurities removal unit has an impurities concentration that closely approximates the maximum impurities concentration that the impurities removal unit can satisfactorily process.

Still a further object of a preferred embodiment of the present invention is to provide a system that maximizes the efficiency of a reverse osmosis unit when used to remove TDS or FDS from wastewater produced by an agricultural processing facility throughout the year despite the differing characteristics of the wastewater produced by the facility throughout the year.

Yet another object of a preferred embodiment of the present invention is to provide an apparatus and method that ensures full regulatory compliance and allows an agricultural processing facility to dispose of wastewater by irrigation at all times throughout the year.

Still a further object of a preferred embodiment of the present invention is to provide an apparatus and method for minimizing the volume of waste produced by a reverse osmosis unit.

Yet still another object of a preferred embodiment of the present invention is to provide an apparatus and method that allows an agricultural processing facility to blend treated wastewater with untreated wastewater and dispose of the blended mixture by irrigation while ensuring full regulatory compliance.

Yet a further object of a preferred embodiment of the present invention is to provide a flocculator upstream of a dissolved air flotation unit where the flocculator has a source of air to agitate the liquid to be treated by the dissolved air flotation unit to promote flocculation and increase the level of dissolved air in the liquid to be treated by the dissolved air flotation unit.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

In summary, one preferred embodiment of the present invention is directed to a system for maximizing the efficiency of a unit for removing at least one impurity from a liquid. The system includes a unit for removing at least one impurity from a liquid and an inlet operably associated with the unit for removing at least one impurity from a liquid for feeding an influent liquid containing at least one impurity to the unit for removing at least one impurity from a liquid. A discharge is operably associated with the unit for removing at least one impurity from a liquid for discharging at least one of: (i) an effluent liquid from the unit for removing at least one impurity from a liquid, and (ii) a waste liquid from the unit for removing at least one impurity from a liquid. The system further includes at least one sensor for sensing at least one condition of at least one of the following: (i) the influent liquid containing at least one impurity; (ii) the effluent liquid; and (iii) the waste liquid. A blending loop for selectively blending at least one of the following: (i) the effluent liquid, (ii) the waste liquid, and (iii) a third liquid, with the influent liquid containing at least one impurity upstream of the unit for removing at least one impurity from a liquid so that the blended mixture of liquids will pass through the unit for removing at least one impurity from a liquid for treatment. A control member is operably associated with the sensor and the blending loop such that when the at least one condition sensed by the sensor is at a first value, the control member permits the blending loop to blend at least one of the following: (i) the effluent liquid, (ii) the waste liquid, and (iii) a third liquid, with the influent liquid containing at least one impurity upstream of the unit for removing at least one impurity from a liquid so that a blended mixture of liquids will pass through the unit for removing at least one impurity from a liquid for treatment.

Another preferred embodiment of the present invention is directed to a system for managing the disposal of wastewater produced by a facility. The system includes at least one wastewater storage area for storing prior to disposal wastewater produced by the facility and a removal unit for removing at least one impurity from a liquid. The removal unit is operably associated with the at least one wastewater storage area such that at least a portion of the wastewater from the at least one wastewater storage area can be directed to the removal unit to remove at least one impurity from the wastewater. A wastewater disposal unit is operably associated with the at least one wastewater storage area such that the wastewater disposal unit can receive wastewater from the at least one wastewater storage area without the wastewater passing through the removal unit. The wastewater disposal unit is further operably associated with the removal unit for receiving a liquid discharged from the removal unit. The system further includes at least a first sensor for sensing at least one condition of the wastewater stored in the at least one wastewater storage area or the liquid discharged from the removal unit and means for supplying to the wastewater disposal unit a blended mixture of wastewater from the at least one wastewater storage area that has not been processed by the removal unit and a liquid discharged from the removal unit wherein the percentage of wastewater from the at least one wastewater storage area that has not been processed by the removal unit that makes up the blended mixture supplied to the wastewater disposal unit varies depending upon the at least one condition sensed by the at least a first sensor.

A further preferred embodiment of the present invention is directed to a method of maximizing the efficiency of a unit for removing at least one impurity including the steps of: (a) providing a unit for removing at least one impurity from a liquid; (b) providing an inlet operably associated with the unit for removing at least one impurity from a liquid for feeding an influent liquid containing at least one impurity to the unit for removing at least one impurity from a liquid for treatment; (c) providing a discharge operably associated with the unit for removing at least one impurity from a liquid for discharging at least one of: (i) an effluent liquid from the unit for removing at least one impurity from a liquid, and (ii) a waste liquid from said unit for removing at least one impurity from a liquid; (d) providing at least one sensor for sensing at least one condition of at least one of the following: (i) the influent liquid containing at least one impurity; (ii) the effluent liquid; and (iii) the waste liquid; and, (e) blending at least one of the following: (i) the effluent liquid, (ii) the waste liquid, and (iii) a third liquid, with the influent liquid containing at least one impurity upstream of the unit for removing at least one impurity from a liquid so that the blended mixture of liquids will pass through the unit for removing at least one impurity from a liquid for treatment.

Still another preferred embodiment of the present invention is directed to a method of managing the disposal of wastewater produced by an agricultural processing facility including the steps of: (a) providing at least one wastewater storage area for storing prior to disposal wastewater produced by the agricultural processing facility; (b) providing a dissolved solids removal unit operably associated with the at least one wastewater storage area such that the wastewater from the at least one wastewater storage area can be directed to the dissolved solids removal unit to remove at least a portion of dissolved solids from the wastewater; (c) providing a wastewater disposal unit operably associated with the at least one wastewater storage area such that the wastewater disposal unit can receive wastewater from the at least one wastewater storage area without the wastewater passing through the dissolved solids removal unit, the wastewater disposal unit being further operably associated with the dissolved solids removal unit so that the wastewater disposal unit can receive a liquid discharged from the dissolved solids removal unit; (d) providing at least a first sensor for determining concentration of dissolved solids in the wastewater stored in the at least one wastewater storage area; (e) supplying wastewater from the at least one wastewater storage area to the dissolved solids removal unit only when the concentration of dissolved solids in the wastewater exceeds a predetermined value for treatment to produce an effluent with a lower concentration of dissolved solids than the concentration of dissolved solids in the wastewater stored in the at least one wastewater storage area; and, (e) supplying to the wastewater disposal unit a blended mixture of wastewater from the at least one wastewater storage area that has not been processed by the dissolved solids removal unit and effluent from the dissolved solids removal unit only when the concentration of dissolved solids in the blended mixture is equal to or below a predetermined value.

Still a further preferred embodiment of the present invention is directed to a system for removing at least one impurity from water or wastewater. The system includes a dissolved air flotation unit for removing at least one impurity from water or wastewater and a flocculator upstream of the dissolved air flotation unit. The flocculator includes an air source for promoting flocculation and increasing the dissolved air content of a liquid passing through the flocculator prior to entering the dissolved air flotation unit.

Yet another preferred embodiment of the present invention is directed to a system for maximizing the efficiency of a unit for removing at least one impurity from a liquid. The system includes a unit for removing at least one impurity from a liquid. An inlet is operably associated with the unit for removing at least one impurity from a liquid for feeding an influent liquid containing at least one impurity to the unit for removing at least one impurity from a liquid. A discharge is operably associated with the unit for removing at least one impurity from a liquid for discharging at least one of: (i) an effluent liquid from the unit for removing at least one impurity from a liquid, and (ii) a waste liquid from the unit for removing at least one impurity from a liquid. The system further includes a blending loop configured to blend at least a second liquid with the influent liquid containing at least one impurity upstream of the unit for removing at least one impurity from a liquid so that the blended mixture of liquids will pass through the unit for removing at least one impurity from a liquid for treatment. The blending loop further being configured to blend the at least a second liquid with the influent containing the at least one impurity when at least one predetermined condition is satisfied.

Still another preferred embodiment of the present invention is directed to a system for maximizing the efficiency of a unit for removing at least one impurity from a liquid. The system includes a removal unit for removing at least one impurity from an influent liquid containing at least one impurity and a blending means operably associated with the removal unit to selectively blend at least a second liquid with the influent liquid containing at least one impurity upstream of the removal unit so that the blended mixture of liquids will pass through the removal unit for treatment. The blending means is configured to blend the at least a second liquid with the influent containing at least one impurity when at least one condition is satisfied and prevent blending the at least a second liquid with the influent containing at least one impurity when the at least one condition is not satisfied.

### BRIEF DESCRIPTION OF THE DRAWINGS

FIG. 1 is a schematic of a preferred form of the present invention.

FIG. 2 is a schematic of an upstream portion of a preferred form of the present invention.

FIG. 3 is a schematic of a downstream portion of a preferred form of the present invention.

### DETAILED DESCRIPTION OF THE PREFERRED EMBODIMENTS OF THE INVENTION

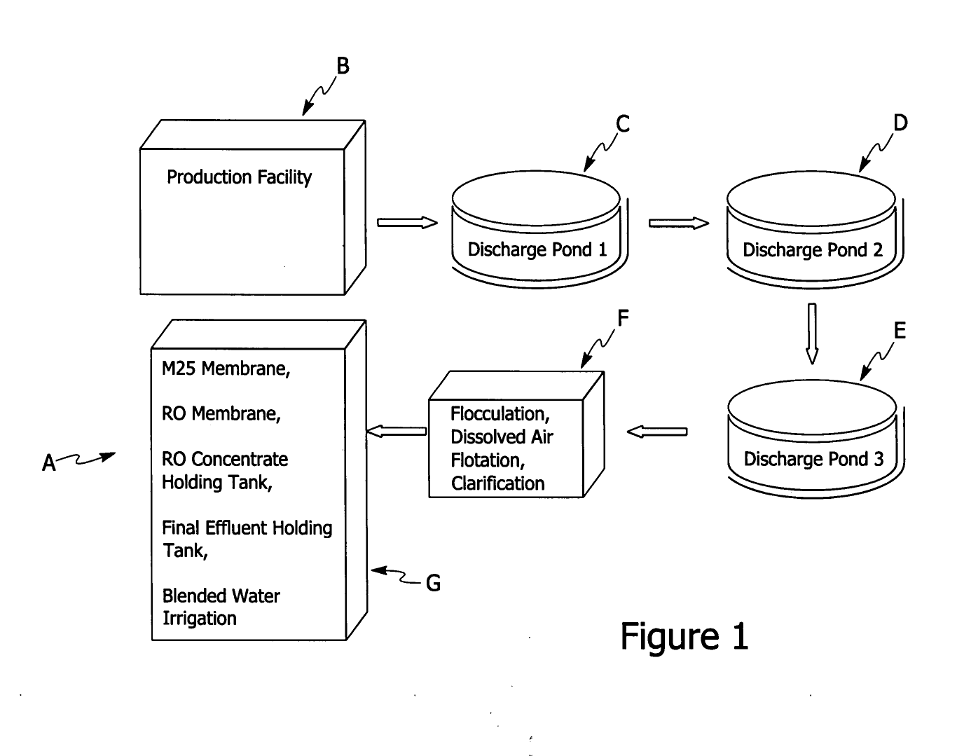

The preferred forms of the invention will now be described with reference to FIGS. 1-3. The appended claims are not limited to the preferred forms and no term and/or phrase used herein is to be given a meaning other than its ordinary meaning unless it is expressly stated otherwise.

### FIGS. 1 Through 3

Referring to FIGS. 1 to 3, a preferred form of liquid management and disposal system A employing a referred form of the invention is illustrated in one of many possible configurations. In the most preferred form, the liquid is wastewater produced by an agricultural processing facility. However, it should be understood that the present invention is not limited to wastewater applications. Rather, numerous aspects of the present invention can be used in water applications as well. Further, the present invention is not limited to use with an agricultural processing facility but rather can be used in any environment where water and or wastewater is processed.

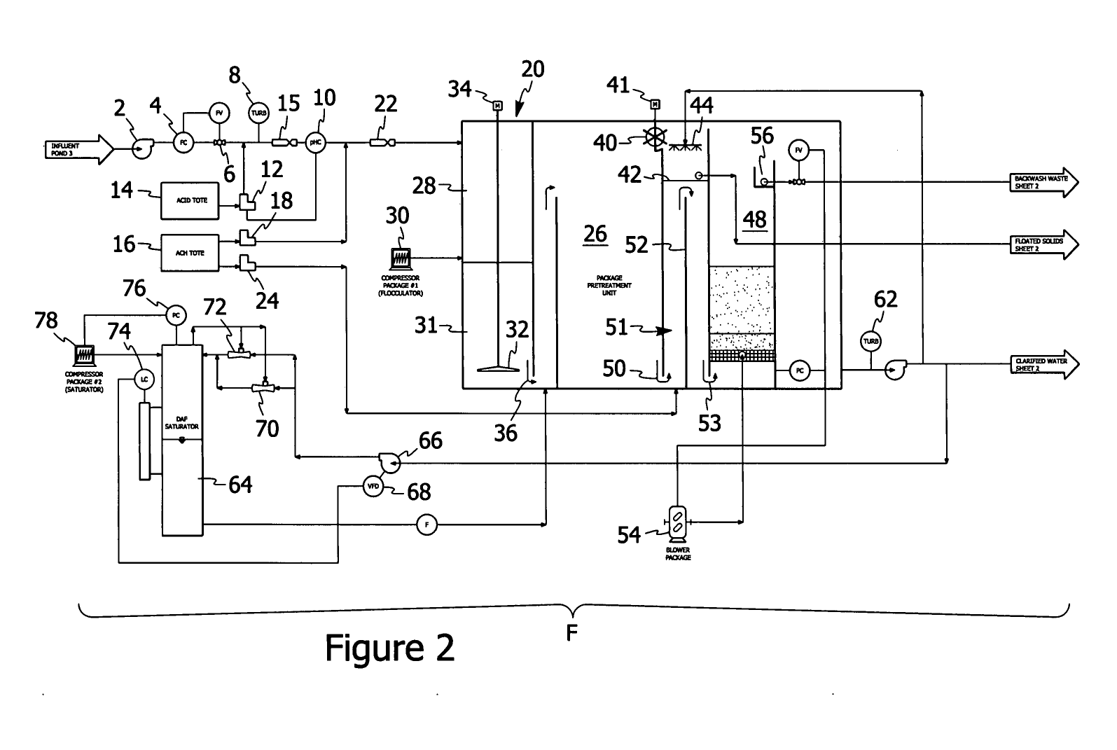

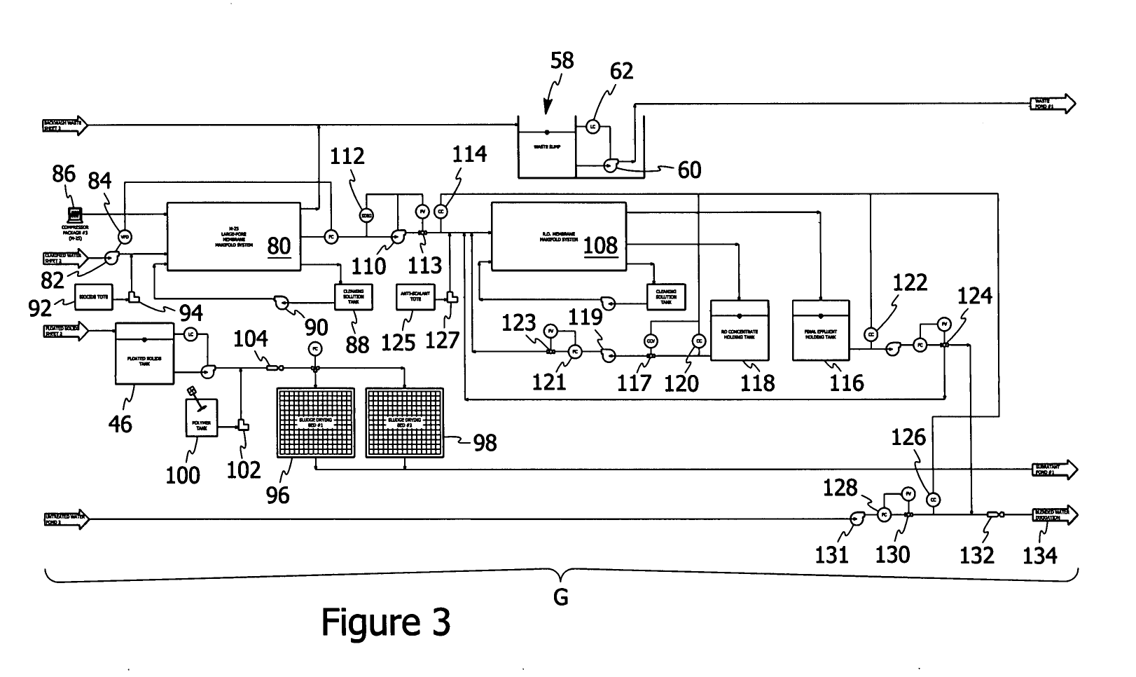

Production facility B is shown as having three wastewater storage ponds C, D and E. The storage ponds are preferably connected in series. It will be readily appreciated that the number and feeding arrangement of wastewater storage ponds may be varied as desired. For example, the storage ponds may be connected in parallel. Referring to FIG. 2, the preferred form of the upstream portion F of the liquid management and disposal system A is schematically illustrated in one of many possible configurations. Referring to FIG. 3, the preferred form of the downstream portion G of the liquid management and disposal system A is schematically illustrated in one of many possible configurations.

Referring to FIG. 2, pump 2 pumps wastewater from wastewater discharge pond E. Flow controller 4 includes a flow meter to determine the flow rate of the influent liquid from pond E. Flow controller 4 is connected to valve 6 to control the flow of influent liquid from pond E to the components downstream of valve 6. Turbidity meter 8 determines the turbidity of the influent liquid at that juncture in the system. Controller 10 monitors the ph level of the influent liquid at that juncture in the system. Controller 10 is connected to diaphragm metering pump 12 which in turn is connected to tank 14. If the ph level of the influent detected by controller 10 is not at the desired level, controller 10 activates pump 12 to pump chemicals from tank 14 to the influent liquid feed line. A static mixer 15 will mix the influent liquid with the injected chemicals to ensure uniform distribution of the injected chemicals in the influent liquid.

Coagulant tank 16 is connected to the influent feed line through a diaphragm metering pump 18 so that one or more coagulants may be added to the influent liquid upstream of flocculator 20. A static mixer 22 sufficiently mixes the added coagulants with the influent liquid. This mixing takes place upstream of flocculator 20. Diaphragm metering pump 24 pumps coagulant to the inlet of the baffle chamber 51 intermediate dissolved air flotation (DAF) unit 26 and filter 48.

Flocculator 20 preferrably has two stages. In the first stage 28, air from air source 30 is supplied to the first stage 28 to agitate the influent liquid passing through the flocculator 20 to promote flocculation. The air from source 30 may be distributed through first stage 28 by an air header and/or an air header having a plurality of air laterals connected thereto disposed in the first stage. The air supplied to first stage 28 also serves the important function of increasing the dissolved air level in the influent liquid. This is particularly beneficial where the level of dissolved air in the influent liquid being processed is below an acceptable level for proper operation of the DAF unit 26. By supplying air to the flocculator, the dissolved air level of the influent liquid can be readily increased without increasing the size of the DAF saturator resulting in a significant cost savings. Second stage 31 includes a mechanical flocculator 32 driven by motor 34 to further promote flocculation. In some circumstances it may be desirable to separate first stage 28 from stage 31 by for example one or more baffles.

The influent liquid is discharged from flocculator 20 into inlet 36 of DAF unit 26. Saturator 64 injects a mixture of dissolved air and influent into the inlet 36 of DAF unit 26. DAF unit 26 causes the impurities in the influent liquid that are not readily settled out to ascend to the upper portion of DAF unit 26 where the sludge scrapper 40 directs the sludge to sludge collector 42. A motor 41 may be used to drive scrapper 40. A sprayer 44 may be employed to wet the sludge to permit the sludge in collector 42 to be readily pumped into a collection tank 46 illustrated in FIG. 3. As seen in FIG. 2, the sprayer may be provided with effluent from filter 48.

The effluent from DAF unit 26 is discharged through outlet 50 into baffle chamber 51 to promote additional mixing and flocculation. Specifically, the liquid travels upwardly on the upstream side of baffle partition 52 and downwardly on the downstream side baffle partition 52. Subsequently, the liquid exits the baffle chamber 51 through outlet 53 and upwardly through filter 48. Filter 48 may be an upflow filter of the type disclosed in U.S. Pat. No. 5,314,630. However, it will be readily appreciated that any suitable filter may be used. The influent liquid passes through the granular filter media in filter 48 to remove impurities in the influent liquid. A blower 54 is connected to the filter 48 to provide air to assist in washing filter 48. The washing procedure disclosed in U.S. Pat. No. 5,314,630 may be used. Collection trough 56 collects the impurities trapped in the granular media filter bed that are released during washing of filter 48. The impurities collected in trough 56 are pumped to waste sump 58. Pump 60 is connected to sump 58 and level controller 62 to direct the waste back into pond C. It should be noted, that sump 58 can be completely omitted by merely pumping the contents of trough 56 directly back to pond C or other storage area. A turbidity meter 62 provides turbidity readings for the effluent discharged from filter 48.

Referring to FIG. 2, a portion of the effluent of filter 48 is preferably provided to DAF saturator 64 via pump 66. A variable frequency drive 68 operates pump 66. The portion of the effluent of filter 48 pumped to saturator 64 passes through two venturi elements 70 and 72 arranged in parallel to each other. The flow of liquid through the venturi elements 70 and 72 induces air from the upper portion of saturator 64 into the venturi elements 70 and 72 where the air mixes with the liquid and the mixture is subsequently directed into saturator 64. The mixture of air and liquid travels from the saturator 64 to the inlet 36 of the DAF unit 26. Level controller 74 controls the level of the air/liquid mixture in saturator 64. Pressure controller 76 is connected to the saturator 64 and the air source 78 to control the air in saturator 64.

The portion of the effluent discharged by filter 48 that is not routed to saturator 64 is directed to membrane manifold unit 80. A pump 82, variable frequency drive 84 and flow controller 86 may be used to regulate the flow of effluent to unit 80. Preferably, the membranes in unit 80 are of the large pore type. However, it will be readily appreciated that the size of the pores of the membranes in unit 80 may be varied as desired. Air source 86 is the primary means for washing the membranes in unit 80. A cleaning solution from tank 88 can be supplied to unit 80 by pump 90 to assist in cleaning of the unit 80. Tank 92 and diaphragm metering pump 94 may be employed to supply one or more chemicals to kill the biomass in the influent liquid prior to entering unit 80.

The floated solids discharged from the DAF unit 26 that are stored in tank 46 are periodically pumped to drying beds 96 and 98. The liquid discharged from the drying beds is preferably returned to pond C through any suitable means. Tank 100 stores polymers used to assist in the dewatering process. Diaphragm metering pump 102 pumps the chemicals from tank 100 into the floated solids feed line upstream of static mixer 104. The static mixer 104 in turn mixes the floated solids with the polymers prior to entry into the drying beds. Valve 106 regulates the flow to the drying beds.

The waste from unit 80 is directed to sump 58. If sump 58 is omitted the waste from unit 80 may be directed back into pond C. The effluent from unit 80 is pumped into reverse osmosis unit 108 via pump 110. Silt Density Index (SDI) controller 112 controls pump 110 and valve 113 to ensure that the influent liquid entering the RO unit 108 does not exceed the maximum acceptable SDI for the RO unit 108.

Conductivity controller 114 preferably includes a conductivity sensor for sensing the conductivity of the influent liquid entering the RO unit 108. The dissolved solids concentration can be determined from the conductivity readings due to the fact that the dissolved solids concentration is proportional to conductivity. Preferably, the effluent form the RO unit 108 is discharged into an effluent holding tank 116 or other storage area or device. The waste from RO unit 108 is preferably discharged into holding tank 118 or other storage area or device. Conductivity controller 120 is connected in such a manner as to determine the conductivity and hence concentration of dissolved solids in the waste discharged by the RO unit 108. Conductivity controller 122 is connected in such a manner as to determine the conductivity and hence concentration of dissolved solids in the effluent discharged by the RO unit 108. By determining the dissolved solids concentration of the influent, the effluent and/or the waste of unit 108, one can readily maximize the efficiency of unit 108. Specifically, if the conductivity of the influent entering unit 108 indicates that the dissolved solids concentration level is lower than the level at which unit 108 optimally operates then waste discharged from unit 108 may be blended with the influent entering the unit 108 until an optimal dissolved solids concentration is reached. To achieve such blending, valve 117 is open and pump 119 pumps the waste liquid through flow controller 121 and flow control valve 123. Flow controller 121 and flow control valve 123 allow one to readily adjust the flow rate of the waste liquid. It will be readily appreciated that if the dissolved solids concentration is too high in the waste, the aforementioned blending will not be permitted. Similarly, if the dissolved solids concentration of the influent is too high for unit 108, the effluent can be blended with the influent prior to entering the unit 108 to reduce the dissolved solids concentration to an optimal level for the unit 108. Valve 124 controls whether the effluent from unit 108 is blended with the influent entering the unit 108 or blended with untreated water from pond E and subsequently conveyed to an irrigator.

An anti-scalant may be pumped from tank 125 via diaphragm metering pump 127 to unit 108.

The operation of unit 108 may be optimized by using the following formula:

$$RO {Feed}_{Optimal} = 1 \approx \frac{{C}_{U} {V}_{U} + {C}_{R} {V}_{R}}{{C}_{optimal} {V}_{optimal}}$$

RO Feed_{Optimal} equals the optimal performance point for an Reverse Osmosis unit;
C_{U} equals the concentration of a contaminant from Upstream Source 80;
V_{U} equals the volumetric flow rate from Upstream Source 80;
C_{R} equals the concentration of a contaminant from the Reverse Osmosis Reject Holding Tank 118;
V_{R} equals the volumetric flow rate from the Reverse Osmosis Reject Holding Tank 118;
Cₒₚₜᵢₘₐₗ equals the optimal concentration of a contaminant processed through RO unit 108; and,
Vₒₚₜᵢₘₐₗ equals the optimal volumetric flow rate processed through RO unit 108.
   It will be readily appreciated that the volumetric flow rate and contamination concentration of the effluent of unit 108 may be substituted for C_{R} and V_{R} in the above formula to determine the optimal blending of effluent with influent when conditions warrant such blending. It should be noted that the influent can be blended with a liquid from a third source (e.g., effluent from the upflow filter provided SDI is satisfied) different from the effluent and waste of unit 108.

As is seen in FIG. 3, the effluent from tank 116 may be selectively blended with untreated wastewater from pond E and then directed to an irrigation system to dispose of the blended mixture of liquid by irrigating the surrounding land of the facility. Conductivity controller 126 determines the conductivity and hence dissolved solids concentration of the untreated wastewater in pond E. Flow controller 128 controls valve 130 to control the amount of untreated wastewater pumped by pump 131 that is ultimately blended with effluent from unit 108. A static mixer 132 mixes the blended liquids prior to discharge by a disposal unit, preferably an irrigation system 134. By blending the effluent from the RO unit with the untreated wastewater, the present invention allows one to readily reduce the dissolved solids concentration to an acceptable level to permit disposal by irrigation. The blending step to permit disposal of the wastewater via irrigation can be optimized by the following formula:

Irrigation Rate=1≈((C_eff×V_eff)+(C_pondE×V_pondE))/(C_maxV_max)

C_eff is concentration of FDS of RO effluent;
V_eff is the volumetric flow rate of RO effluent;
C_pond E is concentration of the FDS of pond E;
V_pondE is the volumetric flow rate of pond E influent; and,
the C_max V_max product represents the maximum level of irrigation without altering ground water. It is to be noted that additional sources may be blended with the wastewater from pond E. For example, the effluent from upflow filter and/or the DAF unit could be blended with the effluent from the RO unit and the wastewater from pond E. The product of the flow rate and contamination concentration for each additional blended liquid would be added to the top half of the above equation. It should be noted that a controller including a microprocessor could control all sensors, valves, meters, etc. to provide for the automatic control of virtually all aspects of the present invention including but not limited to the blending of the influent liquid directed to the RO unit and another source of liquid (e.g., the effluent from the RO unit and/or the waste from the RO unit) and the blending of the effluent from the RO and the untreated wastewater.

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

We claim:

1. A system for maximizing the efficiency of a unit for removing at least one impurity from a liquid, said system comprising:
(a) a unit for removing at least one impurity from a liquid; and,
(b) an inlet operably associated with said unit for removing at least one impurity from a liquid for feeding an influent liquid containing at least one impurity to said unit for removing at least one impurity from a liquid;
(c) a discharge operably associated with said unit for removing at least one impurity from a liquid for discharging at least one of: (i) an effluent liquid from said unit for removing at least one impurity from a liquid, and (ii) a waste liquid from said unit for removing at least one impurity from a liquid;
(d) at least one sensor for sensing at least one condition of at least one of the following: (i) the influent liquid containing at least one impurity; (ii) the effluent liquid; and (iii) the waste liquid;
(e) a blending loop for selectively blending at least one of the following: (i) the effluent liquid, (ii) the waste liquid, and (iii) a third liquid, with the influent liquid containing at least one impurity upstream of said unit for removing at least one impurity from a liquid so that the blended mixture of liquids will pass through said unit for removing at least one impurity from a liquid for treatment; and,
(f) a control member operably associated with said sensor and said blending loop such that when the at least one condition sensed by said sensor is at a first value, said control member permits said blending loop to blend at least one of the following: (i) the effluent liquid, (ii) the waste liquid, and (iii) a third liquid, with the influent liquid containing at least one impurity upstream of said unit for removing at least one impurity from a liquid so that a blended mixture of liquids will pass through said unit for removing at least one impurity from a liquid for treatment.

2. A system as set forth in claim 1, wherein:
(a) the at least one impurity removed by said unit for removing at least one impurity from a liquid is a dissolved solid.

3. A system as set forth in claim 2, wherein:
(a) said unit for removing at least one impurity is a reverse osmosis unit.

4. An system as set forth in claim 1, wherein:
(a) said sensor is a conductivity sensor for determining conductivity of at least one of the following: (i) the influent liquid containing at least one impurity; (ii) the effluent liquid; and (iii) the waste liquid.

5. An system as set forth in claim 4, wherein:
(a) said control member is configured to permit said blending loop to blend the waste liquid with the influent liquid containing at least one impurity when the conductivity of at least the influent liquid containing at least one impurity is equal to or below a first given value.

6. An system as set forth in claim 4, wherein:
(a) said control member is configured to permit said blending loop to blend the waste liquid with the influent liquid containing at least one impurity when the conductivity of the influent liquid containing at least one impurity and the waste liquid are equal to or below a second given value.

7. An system as set forth in claim 6, wherein:
(a) the second given value corresponds to a maximum operating efficiency of said unit for removing at least one impurity.

8. An system as set forth in claim 4, wherein:
(a) said control member is configured to permit said blending loop to blend the effluent liquid with the influent liquid containing at least one impurity when the conductivity of at least the influent liquid exceeds a given value.

9. An system as set forth in claim 8, wherein:
(a) the given value is a conductivity that corresponds to a maximum concentration of the at least one impurity that said unit for removing at least one impurity from a liquid can satisfactorily process.

10. A system for managing the disposal of wastewater produced by a facility, said system including:
(a) at least one wastewater storage area for storing prior to disposal wastewater produced by the facility;
(a) a removal unit for removing at least one impurity from a liquid, said removal unit being operably associated with said at least one wastewater storage area such that at least a portion of the wastewater from the at least one wastewater storage area can be directed to said removal unit to remove at least one impurity from the wastewater;
(c) a wastewater disposal unit being operably associated with said at least one wastewater storage area such that said wastewater disposal unit can receive wastewater from said at least one wastewater storage area without the wastewater passing through said removal unit, said wastewater disposal unit being further operably associated with said removal unit for receiving a liquid discharged from said removal unit;
(d) at least a first sensor for sensing at least one condition of the wastewater stored in said at least one wastewater storage area or the liquid discharged from said removal unit; and,
(e) means for supplying to said wastewater disposal unit a blended mixture of wastewater from said at least one wastewater storage area that has not been processed by said removal unit and a liquid discharged from said removal unit wherein the percentage of wastewater from said at least one wastewater storage area that has not been processed by said removal unit that makes up the blended mixture supplied to said wastewater disposal unit varies depending upon the at least one condition sensed by said at least a first sensor.

11. An apparatus as set forth in claim 10, wherein:
(a) said wastewater disposal unit is an irrigation unit for irrigating land adjacent an agricultural processing facility to dispose of wastewater produced by the agricultural processing facility.

12. An apparatus as set forth in claim 11, wherein:
(a) said at least a first sensor is a conductivity sensor.

13. An apparatus as set forth in claim 12, wherein:
(a) said removal unit is a reverse osmosis unit.

14. An apparatus as set forth in claim 14, further including:
(a) a dissolved air flotation unit upstream of said reverse osmosis unit; and,
(b) a flocculator upstream of said dissolved air flotation unit, said flocculator including an air source for supplying air to wastewater upstream of said dissolved air flotation unit to promote flocculation and increase concentration of dissolved air in the wastewater prior to entering said dissolved air flotation unit.

15. An apparatus as set forth in claim 14, wherein:
(a) said flocculator includes a mechanical flocculator downstream of said air distributor.

16. An apparatus as set forth in claim 15, further including:
(a) an upflow filter downstream of said dissolved air flotation unit and upstream of said reverse osmosis unit, said upflow filter being operably associated with a dissolved air flotation saturator such that at least a portion of effluent from said upflow filter can be supplied, when desired, to said dissolved air flotation saturator, said dissolved air flotation saturator being configured to supply a mixture of effluent from said upflow filter and pressurized air to said dissolved air flotation unit downstream of said flocculator.

17. A method of maximizing the efficiency of a unit for removing at least one impurity, said method comprising the steps of:
(a) providing a unit for removing at least one impurity from a liquid;
(b) providing an inlet operably associated with said unit for removing at least one impurity from a liquid for feeding an influent liquid containing at least one impurity to said unit for removing at least one impurity from a liquid for treatment;
(c) providing a discharge operably associated with said unit for removing at least one impurity from a liquid for discharging at least one of: (i) an effluent liquid from said unit for removing at least one impurity from a liquid, and (ii) a waste liquid from said unit for removing at least one impurity from a liquid;
(d) providing at least one sensor for sensing at least one condition of at least one of the following: (i) the influent liquid containing at least one impurity; (ii) the effluent liquid; and (iii) the waste liquid; and,
(e) blending at least one of the following: (i) the effluent liquid, (ii) the waste liquid, and (iii) a third liquid, with the influent liquid containing at least one impurity upstream of said unit for removing at least one impurity from a liquid so that the blended mixture of liquids will pass through said unit for removing at least one impurity from a liquid for treatment.

18. A method as set forth in claim 17, wherein:
(a) the blending step in paragraph (e) of claim 16 includes blending the waste liquid with the influent liquid containing at least one impurity upstream of said unit for removing at least one impurity from a liquid so that the blended mixture of liquids will pass through said unit for removing at least one impurity from a liquid for treatment.

19. A method as set forth in claim 18, further including the steps of:
(a) providing a first sensor for determining the concentration of at least one impurity in the influent liquid containing at least one impurity
(b) providing a second sensor for determining the concentration of at least one impurity in the waste liquid discharged from said unit for removing at least one impurity from a liquid; and,
(c) blending the waste liquid with the influent liquid containing at least one impurity only when the concentration of the at least one impurity in the influent liquid containing at least one impurity and the concentration of the at least one impurity in the waste liquid is equal to or below a predetermined value.

20. A method as set forth in claim 17, further including the steps of:
(a) providing a first sensor for determining the concentration of the at least one impurity in the influent liquid containing the at least one impurity;
(b) blending the effluent liquid with the influent liquid containing at least one impurity only when the concentration of the at least one impurity in the influent liquid containing the at least one impurity exceeds a predetermined value.

21. A method as set forth in claim 20, wherein:
(a) the predetermined value corresponds to a maximum concentration of at least one impurity that can be satisfactorily processed by said unit for removing at least one impurity from a liquid.

22. A method as set forth in claim 17, wherein:
(a) said unit for removing at least one impurity from a liquid is a reverse osmosis unit, said at least one sensor is a conductivity sensor.

23. A method of managing the disposal of wastewater produced by an agricultural processing facility, said method comprising the steps of:
(a) providing at least one wastewater storage area for storing prior to disposal wastewater produced by the agricultural processing facility;
(b) providing a dissolved solids removal unit operably associated with said at least one wastewater storage area such that the wastewater from the at least one wastewater storage area can be directed to said dissolved solids removal unit to remove at least a portion of dissolved solids from the wastewater;
(c) providing a wastewater disposal unit operably associated with said at least one wastewater storage area such that said wastewater disposal unit can receive wastewater from said at least one wastewater storage area without the wastewater passing through said dissolved solids removal unit, said wastewater disposal unit being further operably associated with said dissolved solids removal unit so that the wastewater disposal unit can receive a liquid discharged from the dissolved solids removal unit;
(d) providing at least a first sensor for determining concentration of dissolved solids in the wastewater stored in said at least one wastewater storage area;
(e) supplying wastewater from said at least one wastewater storage area to said dissolved solids removal unit only when the concentration of dissolved solids in the wastewater exceeds a predetermined value for treatment to produce an effluent with a lower concentration of dissolved solids than the concentration of dissolved solids in the wastewater stored in the at least one wastewater storage area; and,
(e) supplying to said wastewater disposal unit a blended mixture of wastewater from said at least one wastewater storage area that has not been processed by said dissolved solids removal unit and effluent from said dissolved solids removal unit only when the concentration of dissolved solids in the blended mixture is equal to or below a predetermined value.

24. A method as set forth in claim 23, wherein:
(a) the wastewater disposal unit is an irrigation unit.

25. A method as set forth in claim 24, further including the step of:
(a) irrigating land adjacent the agricultural processing facility with the blended mixture to dispose of wastewater produced by the agricultural processing facility.

26. A method as set forth in claim 24, further including the step of:
(a) irrigating land adjacent the agricultural processing facility with only the effluent from the dissolved solids removal unit when the concentration of dissolved solids in the effluent is at a predetermined value.

27. A system for removing at least one impurity from water or wastewater, said system comprising:
(a) a dissolved air flotation unit for removing at least one impurity from water or wastewater; and,
(b) a flocculator upstream of said dissolved air flotation unit, said flocculator includes an air source for promoting flocculation and increasing the dissolved air content of a liquid passing through said flocculator prior to entering said dissolved air flotation unit.

28. A system as set forth in claim 27, further including:
(a) a staturator operably associated with said dissolved air flotation unit for supplying a fluid having a mixture of liquid and air to said dissolved air flotation unit downstream of said flocculator.

29. A system for maximizing the efficiency of a unit for removing at least one impurity from a liquid, said system comprising:
(a) a unit for removing at least one impurity from a liquid; and,
(b) an inlet operably associated with said unit for removing at least one impurity from a liquid for feeding an influent liquid containing at least one impurity to said unit for removing at least one impurity from a liquid;
(c) a discharge operably associated with said unit for removing at least one impurity from a liquid for discharging at least one of (i) an effluent liquid from said unit for removing at least one impurity from a liquid, and (ii) a waste liquid from said unit for removing at least one impurity from a liquid; and,
(d) a blending loop configured to blend at least a second liquid with the influent liquid containing at least one impurity upstream of said unit for removing at least one impurity from a liquid so that the blended mixture of liquids will pass through said unit for removing at least one impurity from a liquid for treatment, said blending loop further being configured to blend the at least a second liquid with the influent containing the at least one impurity when at least one predetermined condition is satisfied.

30. A system as set forth in claim 29, wherein:
(a) the at least a second liquid includes the waste liquid from said unit for removing at least one impurity from a liquid.

31. A system as set forth in claim 29, wherein:
(a) the at least a second liquid includes the effluent liquid from said unit for removing at least one impurity from a liquid.

32. A system for maximizing the efficiency of a unit for removing at least one impurity from a liquid, said system comprising:
(a) a removal unit for removing at least one impurity from an influent liquid containing at least one impurity; and,
(b) blending means operably associated with said removal unit to selectively blend at least a second liquid with the influent liquid containing at least one impurity upstream of said removal unit so that the blended mixture of liquids will pass through said removal unit for treatment, said blending means being configured to blend the at least a second liquid with the influent containing at least one impurity when at least one condition is satisfied and prevent blending the at least a second liquid with the influent containing at least one impurity when the at least one condition is not satisfied.
